(19) United States
(12) Patent Application Publication
(10) Pub. No.: US 2012/0121301 A1
(43) Pub. Date: May 17, 2012

(54) FIXING DEVICE AND IMAGE FORMING APPARATUS

(75) Inventors: Atsuhiko SHIMOYAMA, Tahara-shi (JP); Hiroshi MIZUNO, Aisai-shi (JP); Kuniya MATSUURA, Toyohashi-shi (JP); Masayuki SATOU, Toyohashi-shi (JP); Yasuhiro SUZUKI, Toyokawa-shi (JP)

(73) Assignee: KONICA MINOLTA BUSINESS TECHNOLOGIES, INC., Chiyoda-ku (JP)

(21) Appl. No.: 13/279,629

(22) Filed: Oct. 24, 2011

(30) Foreign Application Priority Data
Nov. 12, 2010 (JP) 2010-253996

(51) Int. Cl. G03G 15/20

(52) U.S. Cl. 399/328

(57) ABSTRACT

Provided is a fixing device successively pressurizing and heating a toner image on a recording member being conveyed to fix the toner image onto the recording member, including a pressure roller, a heating roller arranged opposite to the pressure roller and sandwiching, with the pressure roller, the recording member with the toner image formed thereon to pressurize and heat the toner image on the recording member, thereby fixing the toner image onto the recording member, and a housing storing the pressure roller and the heating roller. The housing has a region covered with an emission reducing member smaller in emission rate than the housing.

This application is based on Japanese Patent Application No. 2010-253996 filed with the Japan Patent Office on Nov. 12, 2010, the entire content of which is hereby incorporated by reference.

### BACKGROUND OF THE INVENTION

1. Field of the Invention

The present invention relates to a fixing device and an image forming apparatus, and more particularly to a fixing device for fixing a toner image formed on a recording member and an image forming apparatus including the fixing device.

2. Description of the Related Art

A recording member with a toner image formed on its surface is introduced into a fixing device provided in an image forming apparatus or the like. This recording member is passed through an area where it is sandwiched between a pressure roller and a heating roller provided within the fixing device, so that the toner image on the recording member is heated and fixed to the recording member.

Conventionally, to reduce heat losses radiated from a pressure roller and a heating roller in a fixing device, for example, Japanese Laid-Open Patent Publication No. 05-188805 (Literature 1), Japanese Laid-Open Patent Publication No, 09-101700 (Literature 2), and Japanese Laid-Open Patent Publication No. 2007-086452 (Literature 3) disclose means such as covering the periphery of the pressure roller and the heating roller with an emission (heat radiation) reflecting plate. Moreover, in a fixing device disclosed in Japanese Laid-Open Patent Publication No. 2004-287318 (Literature 4), a cleaning mechanism is provided for an emission reflecting plate to prevent degradation in reflection efficiency due to adhesion of a contaminant to the emission reflecting plate (toner, wax contained in toner, paper powder).

By providing the emission reflecting plate, however, inconvenience arises in that the fixing device is increased in size. When a cleaning mechanism is provided to avoid contamination of the emission reflecting plate, the fixing device is increased in size, and the mechanism is complicated, resulting in cost increase of the fixing device.

Since the housing surface of the fixing device becomes hot, nonwoven fabric or the like is applied to the housing of the fixing device for some models. However, nonwoven fabric is higher in emission rate than the housing, and is therefore not effective at avoiding emission.

### SUMMARY OF THE INVENTION

The present invention was made to solve the above-described problems, and has an object to provide a fixing device and an image forming apparatus capable of efficiently controlling the amount of heat radiated from the fixing device.

A fixing device based on the present invention is a fixing device successively pressurizing and heating a toner image on a recording member being conveyed to fix the toner image onto the recording member. The fixing device includes a pressure roller, a heating roller arranged opposite to the pressure roller and sandwiching, with the pressure roller, the recording member with the toner image formed thereon to pressurize and heat the toner image on the recording member, thereby fixing the toner image onto the recording member, and a housing storing the pressure roller and the heating roller. The housing has a region covered with an emission reducing member smaller in emission rate than the housing.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates the structure of an image forming apparatus according to an embodiment.

FIG. 2 is a block diagram of an image forming apparatus according to the embodiment.

FIG. 3 is a perspective view of a fixing device according to the embodiment.

FIG. 4 is a cross sectional view taken along the arrow line IV-IV in FIG. 3.

FIG. 5 is a cross sectional view of a fixing device according to another embodiment, equivalent to the view taken along the arrow line IV-IV in FIG. 3.

FIG. 6 is a perspective view of a fixing device according to still another embodiment.

### DESCRIPTION OF THE PREFERRED EMBODIMENTS

A fixing device and an image forming apparatus according to each embodiment based on the present invention will be described below with reference to the drawings. It is noted that, when the number, amount and the like are mentioned in the embodiments described below, the scope of the present invention is not necessarily limited to that number, amount and the like unless otherwise specified. Identical and corresponding parts are denoted by an identical reference character, and repeated description thereof will not be provided. Combination use of the features of the respective embodiments as appropriate has been initially intended.

In the present embodiment, a tandem color printer forming a color image is shown as an example of an image forming apparatus. It is noted that the image forming apparatus according to the present invention should only include a fixing device, and may be a monochrome printer.

[Overall Configuration of Image Forming Apparatus 100]

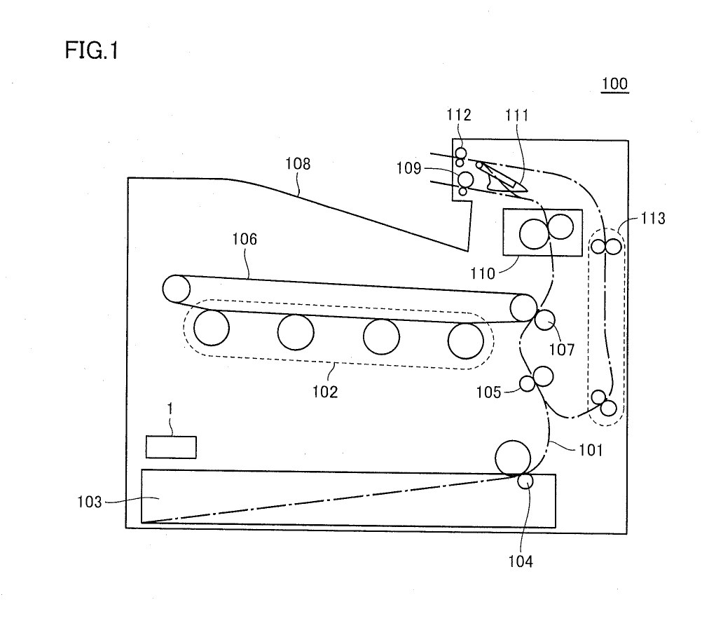

Referring to FIG. 1, in an image forming apparatus 100, upon receipt of a print instruction from a personal computer or the like, a central control unit 1 including a CPU (Central Processing Unit) causes each roller to drive to convey a transfer sheet 101, and causes an imaging unit 102 to form an image to start printing.

Transfer sheet 101 loaded in a sheet-feeding cassette 103 is conveyed by a sheet-feeding roller pair 104, a conveying roller pair 105, an intermediate transfer belt 106, a transfer roller 107, a fixing device 110, and a sheet-ejecting roller pair 109. Ejected transfer sheet 101 is stacked on an ejected-sheet tray 108.

A movable guide 111 is provided in front of sheet-ejecting roller pair 109. Bringing movable guide 111 into a raised position, transfer sheet 101 for which one-side printing has been instructed and transfer sheet 101 for which both-side printing has been instructed, printing on the second side of which has been terminated, are guided to sheet-ejecting roller pair 109. Bringing movable guide 111 into a lowered position, transfer sheet 101 for which both-side printing has been instructed, printing on the first side of which has been terminated, is guided to a reversing roller pair 112.

Transfer sheet 101 guided to reversing roller pair 112 is ejected to the outside of image forming apparatus 100 by a predetermined distance, and is then conveyed again into image forming apparatus 100 by reverse rotation of reversing roller pair 112. At this time, movable guide 111 is brought into the raised position, so that transfer sheet 101 conveyed again is guided to a both-side printing unit 113. Transfer sheet 101 guided to both-side printing unit 113 is conveyed again by conveying roller pair 105, intermediate transfer belt 106, transfer roller 107, fixing device 110, and sheet-ejecting roller pair 109, to be stacked on ejected-sheet tray 108.

This image forming apparatus 100 has a sheet ejection port opening to sheet-ejecting roller pair 109 and a sheet ejection port opening to reversing roller pair 112 in order to improve productivity in both-side printing. This allows a transfer sheet, printing on the first side of which has been terminated, and a transfer sheet, printing on the second side of which has been terminated, to pass by each other smoothly, achieving 100% productivity in both-side printing.

[Block Diagram of Image Forming Apparatus 100]

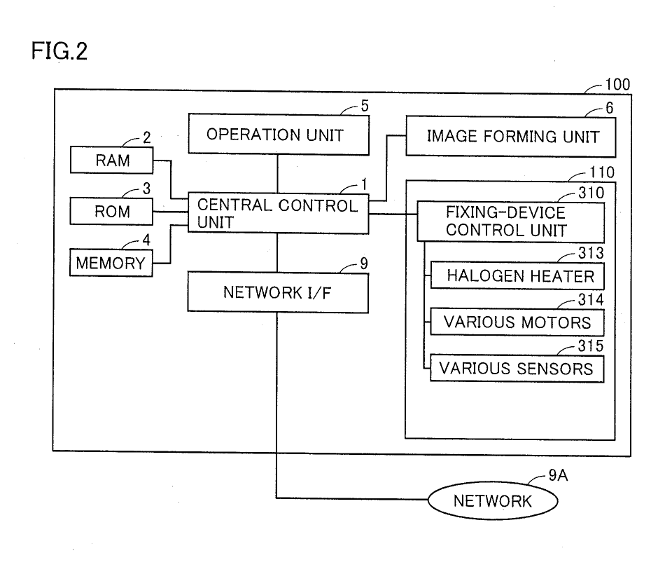

Referring to FIG. 2, image forming apparatus 100 includes central control unit 1 controlling operation of image forming apparatus 100 on the whole. Central control unit 1 includes a CPU (Central Processing Unit).

Image forming apparatus 100 includes a ROM (Read Only Memory) 3 containing data such as a program executed by central control unit 1, a RAM (Random Access Memory) 2 serving as a working area when central control unit 1 executes a program, a memory 4 storing various types of data such as settings when central control unit 1 executes a program, an operation unit 5 including a display unit displaying the state of image forming apparatus 100 and an input unit such as a button for externally entering information, and a network I/F (interface) 9 serving as an interface when conducting communications with external equipment via a network 9A.

In image forming apparatus 100, an image forming unit 6 executes processing of forming and developing an electrostatic latent image in an image forming operation, transferring a toner image onto a transfer sheet in sheet-feeding cassette 103 and introducing the transfer sheet into fixing device 110, such as forming an electrostatic latent image on a photoconductor provided in imaging unit 102, rotating intermediate transfer belt 106, rotating transfer roller 107, rotating sheet-feeding roller pair 104, and processing detection signals issued by sensors as to presence/absence of a transfer sheet in sheet-feeding cassette 103 and the like, as well as processing of ejecting the transfer sheet passed through fixing device 110 through the ejection port. Operation of image forming unit 6 is controlled by central control unit 1.

Fixing device 110 includes a fixing-device control unit 310 controlling operation of fixing device 110 on the whole. In fixing device 110, fixing-device control unit 310 controls operation of a halogen heater 313 (heat source) and various motors 314 based on detection outputs of various sensors 315.

[Structure of Fixing Device 110]

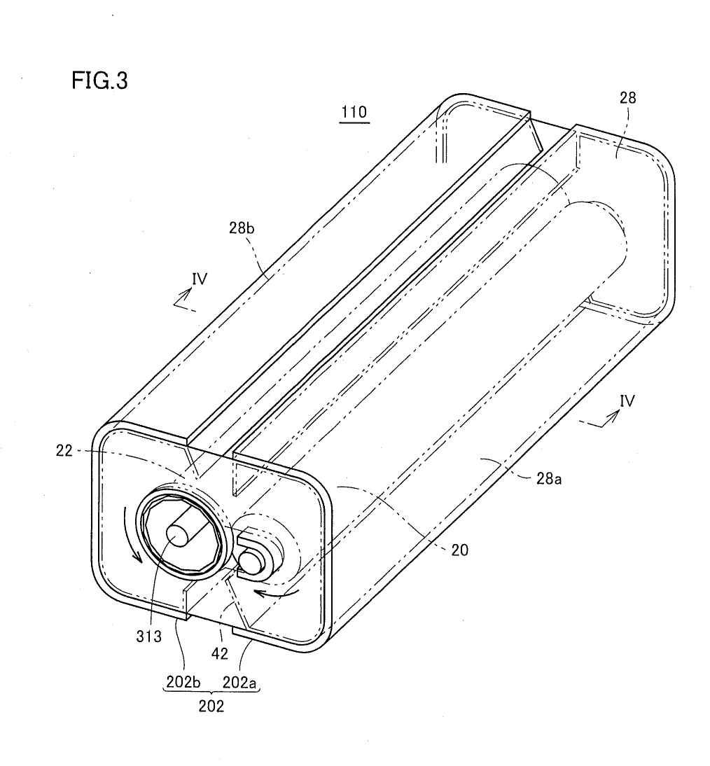

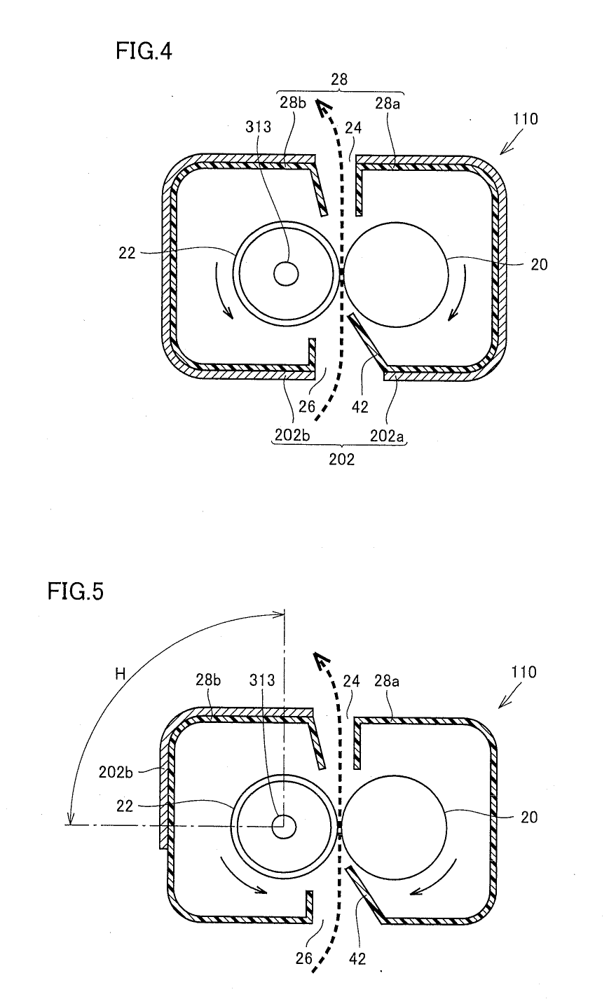

Referring to FIGS. 3 and 4, fixing device 110 includes a housing 28 covering its exterior. Fixing device 110 is provided with an ejection port at the upper side of housing 28 (downstream in the conveying direction of transfer sheet) and a receiving port 26 at the opposite, lower side (upstream in the conveying direction of transfer sheet).

A guide member 42 is provided at receiving port 26. It is noted that, if guide member 42 is configured to be driven by a driving mechanism, it is also possible to make guide member 42 serve as a shutter that opens and closes receiving port 26. In this way, guide member 42 can be provided with a guiding function for leading transfer sheet 101 having passed through a nip part to sheet-ejecting roller pair 109, an insulation function for preventing heat of heating roller 22 from escaping out of fixing device 110, and a safety function for preventing a user from directly touching heating roller 22 and pressure roller 20 at high temperatures.

Pressure roller (pressure member) 20 and heating roller (heating member) 22 with halogen heater 313 built therein are provided within housing 28. Housing 28 has a pressure-roller-side housing 28a arranged closer to pressure roller (pressure member) 20 and a heating-roller-side housing 28b arranged closer to heating roller (heating member) 22. It is noted that, although the illustration shows the structure in which halogen heater 313 is built only in heating roller 22, it is also possible to use a fixing device with a halogen heater built in pressure roller 20.

A transfer sheet carried in through receiving port 26 at the lower side of housing 28 passes through the nip part where it is sandwiched between pressure roller 20 and heating roller 22. A toner image on the transfer sheet is thereby pressurized and heated, so that the toner image is fixed onto the transfer sheet. The transfer sheet is then sent out of fixing device 110 through an ejection port 24.

In fixing device 110, the transfer sheet is pressed by pressure roller 20 and heating roller 22 so as to form the nip part. The nip part is formed so as not to leave any gap in a region other than the transfer sheet while the transfer sheet is passed therethrough.

Referring again to FIG. 2, a contact- or noncontact-type temperature detection sensor for detecting the roller temperature is provided for heating roller 22. Halogen heater 313 is controlled to be turned on/off based on the temperature detected by this temperature sensor, allowing heating roller 22 to be maintained at a suitable temperature (e.g., at 200° C. in printing).

Fixing-device control unit 310 controls driving of a motor not shown (included in various motors 314) that rotates heating roller 22 and pressure roller 20 in accordance with timing when the transfer sheet is introduced into fixing device 110.

Herein, heat energy generated by halogen heater 313 is consumed at the nip part formed by pressure roller 20 and heating roller 22 so as to fuse toner on transfer sheet 101, while residual heat is consumed by warming the surrounding air, pressure-roller-side housing 28a and heating-roller-side housing 28b.

Further, when the surrounding air flows out of fixing device 110 through a sheet path or the like so that heat is radiated to the outside of pressure-roller-side housing 28a and heating-roller-side housing 28b, the surrounding air, pressure-roller-side housing 28a and heating-roller-side housing 28b drop in temperature, to which heat from heating roller 22 is more likely to be transmitted.

Heat transmission from heating roller 22 to the surrounding air, pressure-roller-side housing 28a and heating-roller-side housing 28b requires excessive warming in order to maintain heating roller 22 at a suitable temperature, causing needless heat energy to be consumed.

[Emission Reducing Member 202]

Housing 28 in the present embodiment is thus covered with an emission reducing member 202 smaller in emission rate than the housing. Covering housing 28 with emission reducing member 202 in this way can improve the heat insulation effect in housing 28. This in result eliminates the necessity to warm excessively in order to maintain heating roller 22 at a suitable temperature, allowing the amount of heat radiated from fixing device 110 to be reduced efficiently. As a result, consumption of needless heat energy can be reduced.

The structure shown in FIGS. 3 and 4 is implemented by a structure in which pressure-roller-side housing 28a is covered with a pressure-roller-side emission reducing member 202a and heating-roller-side housing 28b is covered with a heating-roller-side emission reducing member 202b.

Also in the case of fixing device 110 having halogen heater 313 only in heating roller 22, convection within fixing device 110 and contact between heating roller 22 and pressure roller 20 at the nip part allow pressure roller 20 and pressure-roller-side housing 28a to be also warmed gradually. Therefore, providing an emission reducing member in each of pressure-roller-side housing 28a and heating-roller-side housing 28b can improve the insulation effect.

It is noted that, in the case of a fixing device having a halogen heater in pressure roller 20 as well, a higher heat insulation effect can be achieved since the temperature within pressure-roller-side housing 28a also increases.

In the present embodiment, a resin material is used for housing 28, whose emission rate is about 0.9. On the other hand, in the present embodiment, an effective energy saving effect is achieved by covering housing 28 with emission reducing member 202 lower in emission rate than this housing 28. The emission rate of a material used for emission reducing member 202 is preferably less than or equal to 0.5. Through use of emission reducing member 202 with an emission rate less than or equal to 0.5, an energy saving effect of about 7% can be achieved.

Silver, copper, aluminum, or the like is preferably used for emission reducing member 202. Since silver, copper and aluminum have a very small emission rate less than or equal to 0.05, a high energy saving effect can be achieved. Providing emission reducing member 202 made of aluminum will lead to an energy saving effect of about 15% in terms of power consumption of the fixing device in continuous printing. What is called a TEC value is another index for comparing energy consumption. In terms of TEC value, an energy saving effect of 1.3% will be achieved.

It is noted that emission heat from housing 28 increases where the temperature is higher. Therefore, emission of the fixing device can be reduced efficiently by arranging emission reducing member 202 at a hot section of housing 28 (e.g., a section more than or equal to 80° C. at an upper position including a spot directly above heating roller 22).

The highest insulation effect is achieved by covering the entire surface of housing 28 with emission reducing member 202 as shown in FIGS. 3 and 4, however, if it is difficult in terms of structure or cost, emission reducing member 202 may be arranged mainly at a hot section.

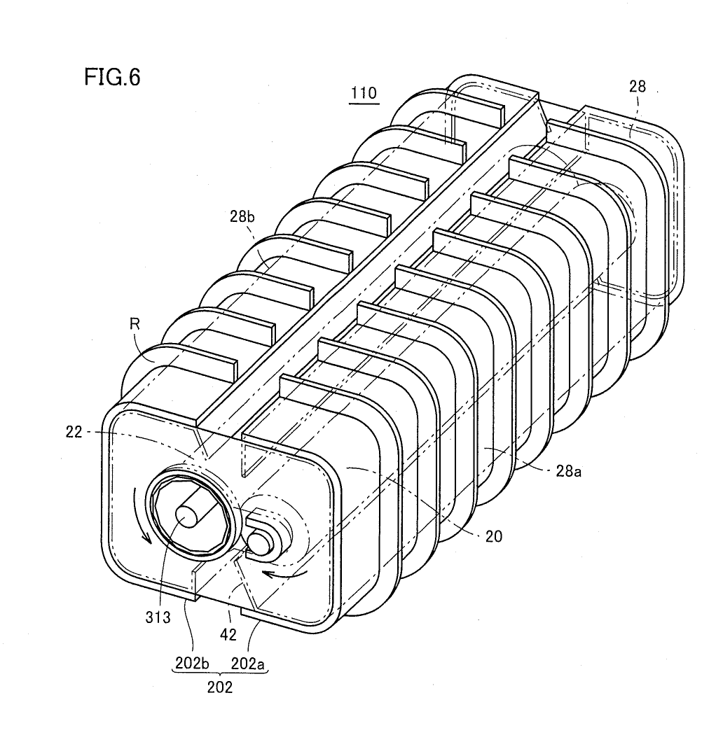

For example, as shown in and FIG. 5, a section ranging from the spot directly above heating-roller-side housing 28b to the opposite side of the nip part (a region indicated by H in FIG. 5) will be the hot section of housing 28 under the influence of ascending air current and convection by roller rotation. When arranging heating-roller-side emission reducing member 202b so as to cover this section, an area ratio will be about 25% with respect to the entire surface of pressure-roller-side housing 28a and heating-roller-side housing 28b. In terms of power consumption of the fixing device in continuous printing, however, an energy saving effect of about 6% can be achieved with respect to 15% described above, leading to an effect ratio of 38%.

Although it is expected that housing 28 rises in surface temperature since the heat insulation effect in fixing device 110 increases, providing ribs R at the surface of housing 28 as shown in FIG. 6 can prevent the user from directly touching the hot section of housing 28.

It is noted that the image forming apparatus shown in FIG. 1 indicates the case of conveying a recording member in the vertical direction (from bottom to top) relative to the arrangement of fixing device 110, however, the present invention is not limited to this conveying direction. For example, the structure of the present invention is also applicable to a fixing device and an image forming apparatus implemented by a structure of conveying a recording member transversely (laterally).

This fixing device is a fixing device successively pressurizing and heating a toner image on a recording member being conveyed to fix the toner image onto the recording member. The fixing device includes a pressure roller, a heating roller arranged opposite to the pressure roller and sandwiching, with the pressure roller, the recording member with the toner image formed thereon to pressurize and heat the toner image on the recording member, thereby fixing the toner image onto the recording member, and a housing storing the pressure roller and the heating roller. The housing has a region covered with an emission reducing member smaller in emission rate than the housing.

In another form, the housing has a pressure-roller-side housing covering the pressure roller and a heating-roller-side housing covering the heating roller. The emission reducing member has a pressure-roller-side emission reducing member covering the pressure-roller-side housing and a heating-roller-side emission reducing member covering the heating-roller-side housing.

In another form, the housing has a pressure-roller-side housing covering the pressure roller and a heating-roller-side housing covering the heating roller. The emission reducing member is arranged to cover a hot section of the heating-roller-side housing in a region above the heating roller.

In another form, the emission reducing member has an emission rate less than or equal to 0.5.

An image forming apparatus based on the present invention has the fixing device described above.

According to these fixing device and image forming apparatus, the amount of heat radiated from the fixing device can be reduced efficiently.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A fixing device successively pressurizing and heating a toner image on a recording member being conveyed to fix said toner image onto said recording member, comprising:
a pressure roller;
a heating roller arranged opposite to said pressure roller and sandwiching, with said pressure roller, said recording member with said toner image formed thereon to pressurize and heat said toner image on said recording member, thereby fixing said toner image onto said recording member; and
a housing storing said pressure roller and said heating roller,
said housing having a region covered with an emission reducing member smaller in emission rate than said housing.

2. The fixing device according to claim 1, wherein
said housing has a pressure-roller-side housing covering said pressure roller and a heating-roller-side housing covering said heating roller, and
said emission reducing member has a pressure-roller-side emission reducing member covering said pressure-roller-side housing and a heating-roller-side emission reducing member covering said heating-roller-side housing.

3. The fixing device according to claim 1, wherein
said housing has a pressure-roller-side housing covering said pressure roller and a heating-roller-side housing covering said heating roller, and
said emission reducing member is arranged to cover a hot section of said heating-roller-side housing in a region above said heating roller.

4. The fixing device according to claim 1, wherein said emission reducing member has an emission rate less than or equal to 0.5.

5. An image forming apparatus having a fixing device successively pressurizing and heating a toner image on a recording member being conveyed to fix said toner image onto said recording member,
said fixing device including
a pressure roller,
a heating roller arranged opposite to said pressure roller and sandwiching, with said pressure roller, said recording member with said toner image formed thereon to pressurize and heat said toner image on said recording member, thereby fixing said toner image onto said recording member, and
a housing storing said pressure roller and said heating roller,
said housing having a region covered with an emission reducing member smaller in emission rate than said housing.

6. The image forming apparatus according to claim 5, wherein
said housing has a pressure-roller-side housing covering said pressure roller and a heating-roller-side housing covering said heating roller, and
said emission reducing member has a pressure-roller-side emission reducing member covering said pressure-roller-side housing and a heating-roller-side emission reducing member covering said heating-roller-side housing.

7. The image forming apparatus according to claim 5, wherein
said housing has a pressure-roller-side housing covering said pressure roller and a heating-roller-side housing covering said heating roller, and
said emission reducing member is arranged to cover a hot section of said heating-roller-side housing in a region above said heating roller.

8. The image forming apparatus according to claim 5, wherein said emission reducing member has an emission rate less than or equal to 0.5.
